(19) United States
(12) Patent Application Publication
(10) Pub. No.: US 2024/0186800 A1
(43) Pub. Date: Jun. 6, 2024

(54) BATTERY MANAGEMENT SYSTEM, BATTERY MANAGEMENT METHOD, AND PROGRAM

(71) Applicant: MIRAI-LABO KABUSHIKI KAISHA, Hachioji-shi (JP)

(72) Inventor: Toshio Hiratsuka, Hachioji-shi (JP)

(73) Assignee: MIRAI-LABO KABUSHIKI KAISHA, Hachioji-shi (JP)

(21) Appl. No.: 18/287,781

(22) PCT Filed: Mar. 29, 2022
(86) PCT No.: PCT/JP2022/015728

§ 371 Date: Oct. 20, 2023

(30) Foreign Application Priority Data
May 14, 2021 (JP) 2021-082809

(51) Int. Cl. H02J 7/00

(52) U.S. Cl. CPC H02J 7/00032; H02J 7/0068

(57) ABSTRACT

A battery management system includes a battery status acquisition unit for acquiring, as secondary battery data, identification data that specifies and identifies the secondary battery and electrical characteristic data that indicates electrical characteristics of the secondary battery when connected, when charging or when discharging, a battery capacity authentication unit for calculating a chargeable capacity of the secondary battery based on the electrical characteristic data and authenticating the chargeable capacity as an authentication capacity and, a battery management database unit provided in the management server for recording the identification data in association with the authentication capacity, a user management database for recording user data related to a user of the secondary battery in association with the identification data, and a user data modification unit for modifying the association between the user data and the identification data.

### TECHNICAL FIELD

The present invention relates to a battery management system, a battery management method, and a program.

### BACKGROUND ART

In recent years, there is a growing use of electric vehicles, hybrid cars, and electric motorcycles using electric power as a power source for mobile vehicles (e.g., automobiles, motorcycles) and converting the power supplied from a secondary battery into kinetic energy. Further, the adoption rate of power-assisted bicycles using electric power as an auxiliary power source of the bicycle is also increasing.

Because these mobile vehicles use the electric power stored in the secondary battery mounted on the mobile vehicles, their travel distance is determined by the chargeable capacity of the secondary battery. In order to increase the travel distance of the mobile vehicle, it is effective to increase the capacity by increasing the size of the secondary battery. However, there is a problem that the increase in the weight of the secondary battery lowers energy efficiency. Thus, there is proposed a battery replacement method for extending travel distance by detachably mounting a secondary battery to a mobile vehicle and replacing the secondary battery having reduced chargeable capacity with a fully charged one.

With this battery replacement method, plural secondary batteries are charged and stored in a battery station, a user brings a mobile vehicle and replaces a used secondary battery, and a battery replacement fee or lease charge can be collected. Further, the replaced used secondary battery is fully charged at the battery station and replaced and used again by a subsequent user. However, the chargeable capacity of the secondary battery is known to deteriorate according to the environment and history of its usage. Even if the secondary battery is fully charged, the chargeable capacity is lower compared to that when it was new. Therefore, with such battery replacement method, battery management becomes necessary in view of the deterioration of the secondary battery.

For example, Patent Document 1 describes an operation server connected to a battery replacement device via a network server to manage deterioration by measuring the number of times the secondary battery was charged and removing any secondary battery charged for a predetermined number of times from those that are lendable.

### RELATED ART DOCUMENTS

### Patent Documents

Patent Document 1: Patent Publication No. 6708805

### SUMMARY OF THE INVENTION

### Problem to be Solved by the Invention

With the conventional art described in Cited Document 1, although the lower limit of the chargeable capacity of a lendable secondary battery can be set by the operation server, the user cannot grasp the actual chargeable capacity or travel distance of the rechargeable battery that has been lent. Therefore, it is difficult for the user to continue running beyond the capacity of the set lower limit, and the battery had to be replaced even when there is surplus of remaining electric power of the secondary battery. Further, since there are individual differences in the secondary battery depending on the manufacturing conditions and usage conditions, it is difficult to accurately grasp the chargeable capacity by way of the deterioration management based on the number of times of charging.

Further, even in applications where the travel distance of the mobile vehicle assumed by the user is short and a small amount of remaining electricity is enough, only a secondary battery exceeding the lower limit set by the operation server is can be lent. Thus, it is difficult to sufficiently make effective use of the secondary battery.

In view of the above-described conventional problems, it is an object of the present invention to provide a battery management system, a battery management method, and a program capable of appropriately using a secondary battery according to the deterioration and chargeable capacity of the secondary battery.

### Means for Solving the Problem

In order to solve the above-mentioned problems, the battery management system according to the present invention performs charging and discharging of a secondary battery connected to a battery station and manages the secondary battery with a management server communicably connected to the battery station. The battery management system is characterized by including a battery status acquisition unit that acquires, as secondary battery data, identification data that specifies and identifies the secondary battery and electrical characteristic data that indicates electrical characteristics of the secondary battery when connected, when charging or when discharging, a battery capacity authentication unit that calculates a chargeable capacity of the secondary battery based on the electrical characteristic data and authenticates the chargeable capacity as an authentication capacity, a battery management database unit provided in the management server and records the identification data in association with the authentication capacity, a user management database that records user data related to a user of the secondary battery in association with the identification data, and a user data modification unit that modifies the association between the user data and the identification data.

With the battery management system of the present invention, it is possible to appropriately use a secondary battery by accurately grasping the deterioration and chargeable capacity of the secondary battery because the chargeable capacity of the secondary battery is calculated and the chargeable capacity is authenticated as an authentication capacity based on electrical characteristic data acquired from the secondary battery.

Further, according to one aspect of the present invention, the user data modification unit modifies the association of the user data and the identification data based on the authentication capacity.

Further, according to one aspect of the present invention, there is further provided a user terminal communicably connected to the battery station or the management server. The user data modification unit modifies the association between the user data and the identification data based on an input result from the user terminal.

Further, according to one aspect of the present invention, there is further provided a distribution server communicably connected to the management serve. The distribution server includes a presentation unit that presents the authentication capacity of the secondary battery identified by the identification data to another user, and a receiving unit that receives acquisition offer data from the other user. The user data modification unit modifies the association between the user data and the identification data based on the acquisition offer data.

Further, according to one aspect of the present invention, the electrical characteristic data includes one of a full charge voltage, a full discharge voltage, an open circuit voltage, a closed circuit voltage, a charge characteristic, a discharge characteristic, an internal resistance, a temperature characteristic, a load characteristic, a cyclic use history data, or impedance.

Further, according to one aspect of the present invention, the battery management database records plural acquisition times and dates of the electrical characteristic data in association with the identification data. The battery capacity authentication unit authenticates the authentication capacity based on a temporal change of the electrical characteristic data.

Further, the battery management method according to the present invention is characterized by including a battery status acquisition step for acquiring secondary battery data including identification data that specifies and identifies a secondary battery and electrical characteristic data that indicates electrical characteristics of the secondary battery when connected, when charging or when discharging, a battery capacity authentication step for calculating a chargeable capacity of the secondary battery based on the electrical characteristic data and authenticating the chargeable capacity as an authentication capacity, a battery data management step for recording the identification data in association with the authentication capacity, a user management step for recording user data related to a user of the secondary battery in association with the identification data, and a user data modification step for modifying the association between the user data and the identification data.

Further, the program according to the present invention causes a computer to perform procedures including a battery status acquisition procedure for acquiring secondary battery data including identification data that specifies and identifies a secondary battery and electrical characteristic data that indicates electrical characteristics of the secondary battery when connected, when charging or when discharging, a battery capacity authentication procedure for calculating a chargeable capacity of the secondary battery based on the electrical characteristic data and authenticating the chargeable capacity as an authentication capacity, a battery data management procedure for recording the identification data in association with the authentication capacity, a user management procedure for recording user data related to a user of the secondary battery in association with the identification data, and a user data modification procedure for modifying the association between the user data and the identification data.

### Effects of the Invention

The present invention can provide a battery management system, a battery management method, and a program that enables appropriate use of a secondary battery according to the deterioration and chargeable capacity of the secondary battery.

### BRIEF DESCRIPTION OF THE DRAWINGS

FIG. 1 is a block diagram schematically illustrating a configuration of a battery management system 100 according to the first embodiment.

FIG. 2 is a block diagram schematically illustrating a configuration of a battery 40 to be managed by a battery management system 100 according to the first embodiment.

FIG. 3 is a schematic diagram illustrating an example of the usage of a battery management system 100 according to the first embodiment.

FIG. 4 is a flowchart illustrating a procedure of a battery management method according to the first embodiment.

FIG. 5 is a block diagram schematically illustrating a configuration of a battery management system 110 according to the second embodiment.

FIG. 6 is a flowchart showing a procedure of battery distribution with a battery management method according to the second embodiment.

FIG. 7 is a schematic diagram illustrating an outline of an autonomous type battery station 10 according to the third embodiment.

FIG. 8 is a schematic diagram illustrating an outline of a battery replacement area 1000 according to the fourth embodiment.

### MODES FOR CARRYING OUT THE INVENTION

### First Embodiment

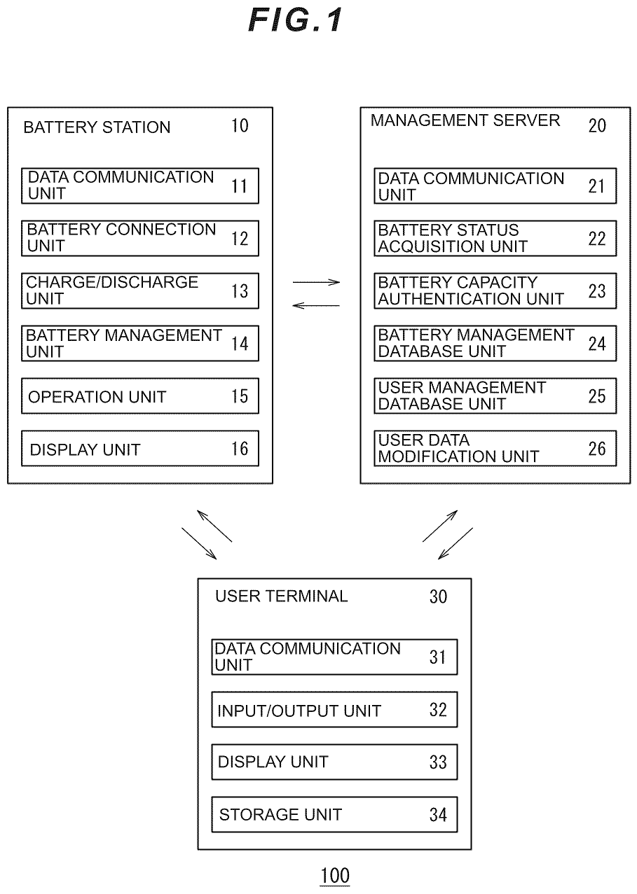

Hereinafter, embodiments of the present invention are described in detail with reference to the drawings. The same or equivalent components, members, and processes illustrated in the respective drawings are denoted by the same reference numerals, and duplicate descriptions are omitted as appropriate. FIG. 1 is a block diagram schematically illustrating a configuration of a battery management system 100 according to this embodiment. As illustrated in FIG. 1, a battery management system 100 includes a battery station 10, a management server 20, and a user terminal 30, each of which is connected to each other to be able to perform data communication.

The battery station 10 is externally supplied with electric power and is a device to be connected to the below-described battery (secondary battery) for charging, discharging, and permitting usage to a user. As illustrated in FIG. 1, the battery station 10 includes a data communication unit 11, a battery connection unit 12, a charge/discharge unit 13, a battery management unit 14, an operation unit 15, and a display unit 16. The configuration of the battery station 10 is not limited in particular. It may be a device with a large housing that is installed in a public area or a small size device that is installed in each home.

The data communication unit 11 is a part that performs data communication with the outside of the battery station 10. The configuration of the data communication unit 11 is not limited in particular. It may be provided by wired connection or wireless connection. The communication protocol applied is not limited in particular, and a publicly known communication protocol may be used. Further, a publicly known data communication path may be used as the path for allowing the data communication unit 11 to perform data communication, such as an optical fiber network, a satellite communication network, a telephone line network, or a mobile communication network.

The battery connection unit 12 is a part that ensures at least electrical connection with the below-described battery. By connecting the battery to the battery connection unit 12, electric power can be exchanged between the battery station 10 and the battery. Further, the battery connection unit 12 preferably includes a locking mechanism or the like for restricting the attachment and detachment of the battery. Although FIG. 1 illustrates an example in which a single battery connection unit 12 is provided in the battery station 10, plural battery connection units 12 may be provided in the battery station 10.

The charge/discharge unit 13 is a part that performs charging and discharging of the battery by controlling the exchange of electric power between the battery connected to the battery connection unit 12. Here, the “charging and discharging of the battery” includes performing a charging operation by supplying electric power to at least the battery, but may also include performing a discharging operation in which power is extracted by consuming the power stored in the battery. The power extracted in the discharging operation of the battery may be supplied to the outside of the battery station 10 from an output unit provided separately.

The battery management unit 14 is a part that stores, for example, data of the battery connected to the battery connection unit 12 and the operation status of the charge/discharge unit 13. In addition, the battery management unit 14 controls the removal of the battery 40 from the battery connection unit 12 along with controlling the charge/discharge operation by the charge/discharge unit 13.

The operation unit 15 is an input device that allows a user or an operator to control the operation of the battery station 10. The configuration of the operation unit 15 is not limited in particular. For example, a publicly known device such as a lever, a button, a dial, a mouse, a keyboard or a touch-panel type input device may be used. The user or the operator operates the operation unit 15 to remove the battery, perform charging and discharging operations of the battery, select an action from presented options, and perform a fee payment operation or the like.

The display unit 16 is a part that displays data managed by the battery management unit 14 and options for action selection. A publicly known image display device may be used. The specific configuration of the display unit 16 is not limited in particular. For example, a publicly known type such as a liquid crystal display device or an organic EL display device may be used. In a case where a touch-panel type input device is used as the operation unit 15, a display function of the display unit 16 may be installed into the operation unit 15.

The management server 20 is a data processing device connected to plural battery stations 10 and plural user terminals 30 in a data communicable manner and manages batteries according to a predetermined procedure. As illustrated in FIG. 1, the management server 20 includes a data communication unit 21, a battery status acquisition unit 22, a battery capacity authentication unit 23, a battery management database unit 24, a user management database unit 25, and a user data modification unit 26.

The data communication unit 21 is a part that performs data communication with the outside of the management server 20. The configuration of the data communication unit 21 is not limited in particular. It may be provided by wired connection or wireless connection. The communication protocol applied is not limited in particular, and a publicly known communication protocol may be used. Further, a publicly known data communication path may be used as the path for allowing the data communication unit 21 to perform data communication, such as an optical fiber network, a satellite communication network, a telephone line network, or a mobile communication network.

The battery status acquisition unit 22 is a part that acquires data of the battery connected to the battery connection unit 12 as secondary battery data. The secondary battery data includes identification data that specifies and identifies the connected battery and electrical characteristic data indicating the electrical characteristics of the battery when connected, when charging, or when discharging. The acquisition of the secondary battery data by the battery status acquisition unit 22 is performed by acquiring data regarding the status and operation of the battery connection unit 12, the charge/discharge unit 13, and the battery management unit 14 transmitted from the data communication unit 11 to the data communication unit 21. FIG. 1 illustrates an example in which the battery status acquisition unit 22 is provided in the management server 20. However, the battery status acquisition unit 22 may be provided in the battery station 10. In such a case, the secondary battery data acquired by the battery status acquisition unit 22 is transmitted from the data communication unit 11 to the management server 20 via the data communication unit 21.

The battery capacity authentication unit 23 is a part that calculates the chargeable capacity of the battery based on the electrical characteristic data included in the secondary battery data acquired by the battery status acquisition unit 22 and authenticates the calculated capacity as authentication capacity. Here, the chargeable capacity indicates the amount of electric power that can be extracted from full charge to full discharge when full charge and full discharge of the battery are set.

The battery management database unit 24 is a database that records the identification data assigned to each battery in association with the authentication capacity calculated and authenticated by the battery capacity authentication unit 23. The user management database unit 25 is a database that records the user data related to the user of the battery in association with the identification data assigned to each battery. The user data modification unit 26 is a part that modifies the association between the user data and the identification data based on the below-described various data and records it in the user management database unit 25.

The user terminal 30 is a data device operated by a user of the battery and is data-communicably connected to the battery station 10 and the management server 20 for performing data display and operation input. The user terminal 30 corresponds to the user terminal in the present invention. As illustrated in FIG. 1, the user terminal 30 includes a data communication unit 31, an input/output unit 32, a display unit 33, and a storage unit 34. The configuration of the user terminal 30 is not limited in particular. For example, publicly known devices such as a portable telephone terminal device, a portable computer device, or a stationary type computer device may be used. Further, the user terminal 30 may be combined with the battery station 10 to form a single unit or integrated with a mobile object that is driven by the battery 40.

The data communication unit 31 is a part that performs data communication with the outside of the user terminal 30. The configuration of the data communication unit 31 is not limited in particular. It may be provided by wired connection or wireless connection. The communication protocol applied is not limited in particular, and a publicly known communication protocol may be used. Further, a publicly known data communication path may be used as the path for allowing the data communication unit 31 to perform data communication, such as an optical fiber network, a satellite communication network, a telephone line network, or a mobile communication network.

The input/output unit 32 is a device for allowing the user to input a predetermined command and outputting data. The configuration of the input/output unit 32 is not limited in particular. For example, a publicly known device such as a lever, a button, a dial, a mouse, a keyboard, a touch-panel type input device, a speaker, or an indicator may be used.

The display unit 33 is an image display device for presenting an image or character data to the user. The specific configuration of the display unit 33 is not limited in particular. For example, a publicly known device such as a liquid crystal display device or an organic EL display device may be used. In a case where a touch-panel type input device is used as the input/output unit 32, a display function of the display unit 33 may be installed in the input/output unit 32.

The storage unit 34 is a storage device that includes a recording medium capable of reading and writing data for recording data to be exchanged via the data communication unit 31 or a program enabling the user terminal 30 to execute a predetermined procedure. As the recording medium included in the storage unit 34, a publicly known device such as a magnetic recording medium, a magneto-optical recording medium, an optical recording medium, or a nonvolatile storage device may be used.

The functions of the respective parts of the above-described battery station 10, the management server 20, and the user terminal 30 are realized by executing a predetermined program by hardware which performs a predetermined operation, a central processing unit (CPU: Central Processing Unit), and a storage device.

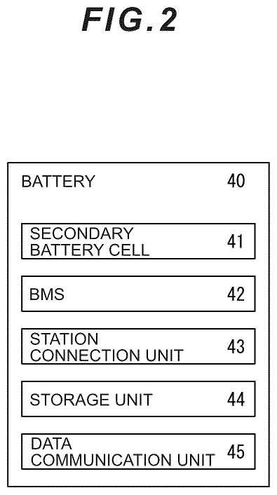

FIG. 2 is a block diagram schematically illustrating a configuration of a battery 40 that is managed by the battery management system 100 according to this embodiment. As illustrated in FIG. 2, the battery 40 includes a secondary battery cell 41, a BMS (Battery Management System) 42, a station connection unit 43, a storage unit 44, and a data communication unit 45. The battery 40 of this embodiment is to be connected to the battery connection portion 12 of the battery station 10, charged/discharged, removed from the battery station 10, and mounted on a mobile object for supplying electric power to the mobile object. The battery 40 corresponds to the secondary battery of the present invention.

The secondary battery cell 41 is a member that is packaged with, for example, electrolyte that accumulates and releases electric charges by an electrochemical reaction, positive and negative electrodes, and a separator. The battery 40 includes plural secondary battery cells 41 that are connected in series or parallel to each other to obtain a desired output. The electrolyte included in the secondary battery cell 41 is not limited in particular. For example, publicly known materials such as various lithium-ion batteries, nickel metal hydride batteries, or nickel zinc batteries may be used. Further, the electrolyte may be a liquid or a solid.

The BMS 42 is a member electrically connected to the outside of the battery 40 and to the secondary battery cell 41 for controlling the charging and discharging of the secondary battery cell 41. The BMS 42 measures a voltage value and a current value of each of the secondary battery cells 41, records data such as their charging history and discharging history, and controls the connection with outside and the secondary battery cells 41 based on the data.

The station connection unit 43 is a part that ensures at least electrical connection with the battery connection unit 12 of the battery station 10. By connecting the station connection unit 43 to the battery connection unit 12, electric power can be exchanged between the battery station 10 and the battery. Further, it is preferable for the station connection unit 43 to have a mechanically connecting part that corresponds to a locking mechanism provided in the battery connection unit 12.

The storage unit 44 is a storage device that includes a recording medium capable of reading and writing data for recording data to be exchanged via the data communication unit 45 or identification data for identifying each of the batteries 40. As the recording medium included in the storage unit 44, a publicly known device such as a magnetic recording medium, a magneto-optical recording medium, an optical recording medium, or a nonvolatile storage device may be used.

The data communication unit 45 is a part that performs communication of data acquired by the BMS 42 or data recorded in the storage unit 44 with the battery station 10 connected via the station connection unit 43. Further, a wired or wireless communication device may be used as the data communication unit 45 and directly perform data communication with the battery station 10 or the management server 20.

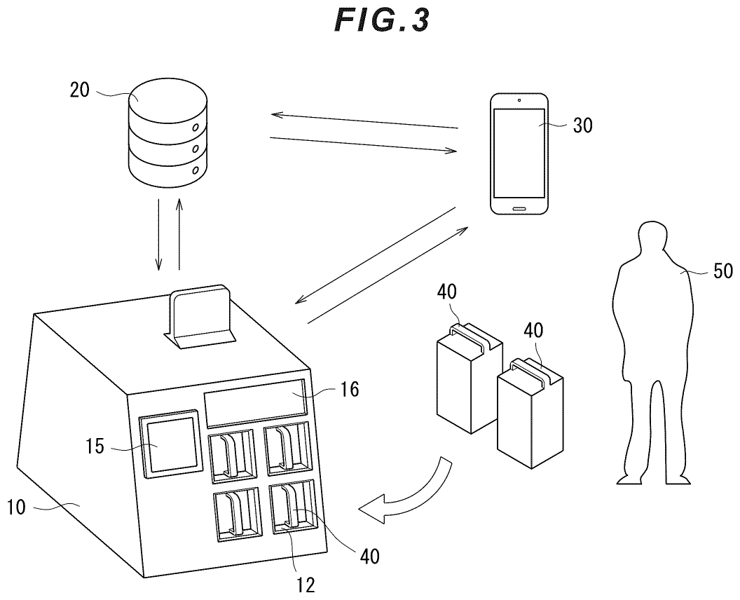

FIG. 3 is a schematic diagram illustrating an example of the usage of the battery management system 100 according to this embodiment. A user 50 of a battery 40 brings a used battery 40 to the battery station 10 and connects the battery connection unit 12 to the station connection unit 43. In the battery station 10, charging and discharging of the connected battery 40 is performed along with managing the battery 40 by performing data communication with the management server 20. Further, the user 50 operates the user terminal 30 to perform data communication with the battery station 10 and the management server 20 and performs input operations required for managing the battery 40.

In the example illustrated in FIG. 3, the battery station 10 is provided with plural accommodation units for accommodating the batteries 40 therein. By accommodating the battery 40 in the accommodation unit, the battery connection unit 12 and the station connection unit 43 are automatically connected. Further, the locking mechanism serves to restrict the mechanical attachment/detachment of the battery 40 accommodated in the accommodation unit. The battery 40 can be removed from the accommodation unit by releasing the locking mechanism in accordance with an attachment/detachment instruction from the battery management unit 14. In this situation, the battery 40 targeted to be released by the battery management unit 14 may be different from the one that the user 50 had immediately brought before, so that the user 50 may obtain a charged battery 40 from the battery station 10.

Here, with the battery 40, in a case where a “full charge” (100%) is assumed as a state in which the BMS 42 stops charging by activating an overcharge protection function and a “full discharge” (0%) is assumed as a state in which the BMS 42 stops discharging by activating an overdischarge protection function, the amount of electric power required to charge from “full discharge” (0%) to “full charge” (100%) is the capacity that the battery 40 can be charged. Further, in a case where the chargeable capacity of a brand-new battery 40 is assumed as “new capacity” and where the chargeable capacity of a used battery 40 is assumed as “deterioration capacity”, “deterioration capacity/new capacity” is assumed as a “deterioration rate”.

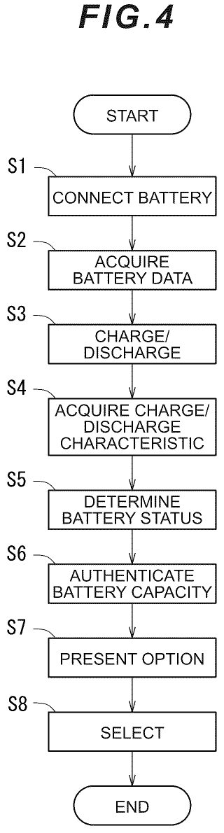

FIG. 4 is a flowchart illustrating the procedure of a battery management method according to this embodiment. As illustrated in FIG. 3, the management method starts in a case where the user 50 charges a used battery 40 at the battery station 10. The trigger for the start may be, for example, when insertion of the battery 40 into the accommodation part of the battery station 10 is detected, when contact between the battery connection unit 12 and the station connection unit 43 is detected, or when the user 50 inputs a request by operating the input/output unit 32 or the operation unit 15.

Step S1 is a battery connection step that ensures an electric connection between the battery connection unit 12 and the station connection unit 43. As described above, when an operation such as accommodating the battery 40 in the accommodation part is performed, the battery management unit 14 confirms the conduction of the battery connection unit 12 and the station connection unit 43. When it is confirmed that both are conducted and electrically connected, the procedure proceeds to Step S2. In a case where the battery station 10 is provided with a locking mechanism, the battery management unit 14 activates the locking mechanism with respect to the battery 40 to be managed and restricts removal of the battery 40. The locking mechanism is not limited to a specific configuration.

Step S2 is a battery data acquisition step in which secondary battery data is acquired from the connected battery 40 and data regarding the user 50 that used the battery 40 is acquired as user data. The battery data acquisition step corresponds to a part of the battery status acquisition step of the present invention. The battery management unit 14 acquires identification data recorded in the storage unit 44 of the battery 40 and the values of a full charge voltage and the full discharge voltage set in the BMS 42 as a part of electrical characteristic data and transmits the data to the battery status acquisition unit 22.

Further, the battery management unit 14 associates the identification data of the battery 40 with the user data and records the associated data in the user management database unit 25 (user management step). After the battery status acquisition unit 22 acquires the identification data and the electrical characteristic data, the procedure proceeds to step S3. The specific method in which the battery management unit 14 acquires the identification data and the electrical characteristic data is not limited in particular. For example, data communication between the battery connection unit 12 and the station connection unit 43 may be allowed. Wireless data communication between the data communication unit 11 on the side of the battery station 10 and the data communication unit 45 on the side of the battery 40 may be used for allowing direct or indirect data communication therebetween.

Step S3 is a charge/discharge step for charging or discharging the secondary battery cell 41 of the battery 40. In this step, the battery management unit 14 controls the driving of the charge/discharge unit 13 to supply electric power to the secondary battery cell 41 through the battery connection unit 12 and the station connection unit 43 and charge the secondary battery cell 41. Before the charging operation, a discharging operation may be performed for refresh-charging or a short time discharge operation may be performed for acquiring discharge characteristics. After the charge/discharge unit 13 starts charging or discharging, the procedure proceeds to step S4. Even after the transition to step S4, the charge/discharge step is continued to be performed. Here, the circuit configuration and a drive controlling method of the charge/discharge unit 13 is not limited in particular. Publicly known charge/discharge circuits and charge/discharge operations may be used.

Step S4 is a step performed in parallel with the performing of the charge/discharge step. This step is a charge/discharge characteristic acquisition step for acquiring, as a part of the electrical characteristic data, the electrical characteristics at the time of charging or discharging of the battery 40. The charge/discharge characteristic acquisition step corresponds to a part of the battery status acquisition step of the present invention. In parallel with the performing of the charging and discharging process, the battery management unit 14 acquires, as a part of the electrical characteristic data, the voltage value of the secondary battery cell 41 and the current value at the time of the charging and discharging of the secondary battery cell 41 and transmits the data to the battery status acquisition unit 22. The electrical characteristic data acquired by the battery management unit 14 includes, for example, an open circuit voltage, a closed-circuit voltage, a charge characteristic, a discharge characteristic, an internal resistance, a temperature characteristic, a load characteristic, cyclic use history data, or impedance. After the battery status acquisition unit 22 acquires the electrical characteristic data, the procedure proceeds to step S5.

Step S5 is a battery status determining step for determining the status of the battery 40 based on the electrical characteristic data of the battery 40. The battery status acquisition unit 22 associates the identification data of the battery 40 and the electrical characteristic data acquired in the battery data acquisition step and the charge/discharge characteristic acquisition step with their acquired time and date and records the associated data in the battery management database unit 24. The battery capacity authentication unit 23 calculates the deterioration state of the secondary battery cell 41 included in the battery 40 based on the electrical characteristic data recorded in the battery management database unit 24, associates the calculated deterioration state, as deterioration data, with the identification data, and records the associated data in the battery management database unit 24. After the battery capacity authentication unit 23 records the deterioration data and the identification data in association with each other, the procedure proceeds to step S6.

Here, as a method of calculating the deterioration state by the battery capacity authentication unit 23, there is a method of calculating the deterioration state based on a predetermined function in which data included in the electrical characteristic data (full charge voltage, full discharge voltage, open circuit voltage, closed circuit voltage, charge characteristic, discharge characteristic, internal resistance, temperature characteristic, load characteristic, cyclic use history data) or data of impedance is used as a parameter. In this case, plural parameters included in the electrical characteristic data may be used. Further, the calculation may be performed by referring to plural electrical characteristic data acquired at different times and dates and performing the calculation based on temporal changes of the electrical characteristic data. Further, although a function used for calculating the deterioration state may be set beforehand, it may be calculated by obtaining an approximate function based on machine learning.

Further, not only is the individual identification number of the secondary battery cell 41 recorded as the identification data of the battery 40 but additional data such as manufacturer data, standard data, or the type of device to be used may also be recorded beforehand, so that the deterioration state may be calculated according to the electrical characteristic data added with the additional data. Here, the calculation of the deterioration state refers to obtaining the relationship between the actual discharge capacity and the discharge voltage at the present time. It is different from the discharge characteristic that is set when the battery 40 is brand new.

In this embodiment, the battery capacity authentication unit 23 of the management server 20 calculates authentication capacity based on the electrical characteristic data at the time of connection, charging, or discharging of the plural batteries 40 accommodated in the plural battery stations 10. Thereby, the accuracy for calculating the chargeable capacity of the battery 40 can be improved.

Step S6 is a battery capacity authentication step that authenticates the chargeable capacity of the battery 40. The battery capacity authentication unit 23 determines the chargeable capacity of the battery 40 at the present time based on the deterioration state of the battery 40 calculated in the battery status determination step and records it as the authentication capacity in association with the identification data in the battery management database unit 24. After the authentication capacity is recorded, the procedure proceeds to step S7. Further, the battery management unit 14 may update the data of the BMS 42 of the battery 40 based on the authentication capacity authenticated by the battery capacity authentication unit 23 and set a new over-discharge voltage and over-charge voltage. Here, the battery status determination step and the battery capacity authentication step are described as separate steps, but both steps may be combined as a battery capacity authentication step.

Step S7 is an option presentation step which presents a battery 40 that is to be used next by the user 50. The battery management unit 14 of the battery station 10 acquires the identification data and the authentication capacity data recorded in the battery management database unit 24 with respect to the plural batteries 40 accommodated in the accommodation unit and displays the authentication capacity of each battery 40 on the display unit 16. This allows the user 50 to grasp the authentication capacity of the battery 40 accommodated in the accommodation unit of the battery station 10 and know the charge capacity indicating which battery 40 and how much the battery 40 can actually be used. After the presentation of the authentication capacity to the user 50 is completed, the procedure proceeds to Step S8.

Here, although this example illustrates displaying the authentication capacity of each battery 40 on the display unit 16, the authentication capacity may be displayed on the display unit 33 of the user terminal 30 via the data communication unit 11 and the data communication unit 31. Further, the type of the mobile object being used and the travel distance per charge capacity may be recorded beforehand in the user data in the user management database unit 25. Thus, in the option presentation step, the travelable distance may be calculated based on the authentication capacity and the user data, and the travelable distance may be presented simultaneously with the authentication capacity.

Step S8 is a selection step for selecting and executing an action from the presented options. The user 50 confirms the authentication capacity of the plural batteries 40 presented on the display unit 16 or the display unit 33 and inputs which of the batteries 40 is to be used from the operation unit 15 or the input/output unit 32. The battery management unit 14 transmits the identification data and the user data of the selected battery 40 to the user data modification unit 26 via the data communication unit 11 and the data communication unit 21. The user data modification unit 26 rewrites the identification data of the battery 40, which is recorded in the user management database unit 25 in association with the user data, into that of the selected input result. Further, the battery management unit 14 releases the locking mechanism of the selected battery 40 and displays a message of the removal of the battery 40 on the display unit 16.

The option presentation step and the selection step of this embodiment correspond to the user data modification step of the present invention because the association of the user data and the identification data is changed based on the authentication capacity of the battery 40.

As described above in this embodiment, the battery capacity authentication unit 23 authenticates authentication capacity based on the electrical characteristic data of the battery 40 acquired by the battery status acquisition unit 22, and the battery 40 to be replaced is presented to the user 50 after notifying the authentication capacity to the user 50. Thereby, the user 50 can appropriately select the battery 40 having the necessary authentication capacity according to his/her expected usage situation and travel distance. For example, if the planned travel distance is long, a battery 40 with a deterioration rate of less than 10% is selected, and if the travel is urgent and a short distance only, a battery 40 with a deterioration rate of approximately 30% is selected. Thus, an appropriate battery 40 can be used according to the deterioration and chargeable capacity of the battery 40.

### Modified Example 1 of the First Embodiment

In the battery management system and the battery management method illustrated in FIG. 1 to FIG. 4, the user 50 selects the battery 40 to be used next from the options after the authentication capacity of the battery 40 has been authenticated by the battery capacity authentication unit 23. However, the selection may be performed automatically according to a predetermined condition.

In this modified example, the user 50 inputs beforehand a condition(s) of the battery 40 to be selected as usage condition data by using the operation unit 15 or the input/output unit 32, and the usage condition data is recorded beforehand as a part of user data in the user management database unit 25. The usage condition data includes, for example, “authentication capacity of 70% or more” and “continuous travelable distance of 50 km or more”. In a case where the continuous travelable distance is used as the usage condition data, the travel distance per charge capacity of the mobile object on which the user 50 rides is recorded beforehand in the user data.

In the battery capacity authentication step in step S6, after the authentication capacity of the battery 40 accommodated in the battery station 10 is authenticated, the user data modification unit 26 refers to the usage condition data of the user 50 recorded in the user management database unit 25, selects the battery 40 having an authentication capacity matching the condition of the usage condition data from the battery management database unit 24, and acquires the identification data. Then, the user data modification unit 26 associates the identification data of the selected battery 40 with the user data and updates the user management database unit 25.

Even in this modified example, a battery 40 suitable for the request of the user 50 can be selected and an appropriate battery 40 can be used according to the deterioration and chargeable capacity of the battery 40 because the condition of the authentication capacity is set as the usage condition data and the association of the user data and the identification data is modified according to the selection of the battery 40 based on the authentication capacity.

### Modified Example 2 of the First Embodiment

In the battery management system and battery management method illustrated in FIG. 1 to FIG. 4, the authentication capacity of a battery 40 is presented to the user 50 and the battery 40 is included as an option regardless of its deterioration rate. Alternatively, a battery 40 whose deterioration has progressed beyond a predetermined deterioration rate may be eliminated from the options and collected.

In this modified example, user data of a collector is recorded beforehand in the user management database unit 25, and a collection condition is recorded in the battery management database unit 24. Here, the collection condition may be set individually for each battery 40. Alternatively, settings that are uniformly applied to all batteries 40 may be recorded.

In the battery capacity authentication process of step S6, after the authentication capacity of the battery 40 accommodated in the battery station 10 is authenticated, the user data modification unit 26 acquires a collection condition from the user control database unit 25 and compares the collection condition with the authentication capacity. In a case where the authentication capacity satisfies the collection condition, the user data modification unit 26 associates the identification data of the battery 40 with the user data of the collector and updates the user management database unit 25.

When the collector performs input of a collection operation with the operation unit 15 of the battery station 10, the battery management unit 14 accesses the user management database unit 25, acquires all of the identification data associated with the user data of the collector, and releases the locking mechanism of the battery 40 that is targeted for collection. This allows the collector to collect a battery 40 that has deteriorated beyond a predetermined deterioration rate, so that the battery 40 can be regenerated or recycled.

Even in this modified example, an appropriate battery 40 can be used and collected according to the deterioration and chargeable capacity of the battery 40 because authentication capacity is set as a collection condition, a battery 40 is collected based on the authentication capacity, and the association of the user data and the identification data is modified accordingly.

### Modified Example 3 of the First Embodiment

The battery management system and battery management method illustrated in FIG. 1 to FIG. 4 present a battery 40 subject for replacement after a battery 40 used by the user 50 is accommodated in the battery station 10. However, a battery subject for replacement may be presented while a battery 40 is being used.

In this modified example, the battery connection step of step S1 is performed after the option presentation step of step S7 and the selection step of step S8 illustrated in FIG. 4. In this modified example, the user 50 may continue to use a battery 40 being used in a case where no battery 40 matching the usage condition expected by the user is accommodated in the battery station 10.

Further, the user terminal 30 may be provided with a GPS (Global Positioning System) device that acquires the position data of the user terminal 30. In addition, the user terminal 30 may access the management server 20 and check the authentication capacity of the battery 40 accommodated in a neighboring battery station 10 from the battery management database unit 24. This allows the user to determine which battery station 10 is accommodating a battery 40 having an authentication capacity that matches his/her expected usage condition even from a remote location. Thereby, an appropriate battery 40 can be used according to the deterioration and chargeable capacity of the battery 40.

### Modified Example 4 of the First Embodiment

In this modified example, a manager of the battery station 10 owns plural batteries 40, and the user 50 has entered into a rental contract, a lease contract, or a subscription-type usage contract with the manager of the battery station 10. In this case, ownership of the battery 40 is not transferred in none of the operations of using, taking out, collecting, or charging the battery 40. Therefore, the battery management unit 14 can attend to each operation merely by modifying the association of the identification data and the user data of the battery 40 with the user management database unit 25.

### Second Embodiment

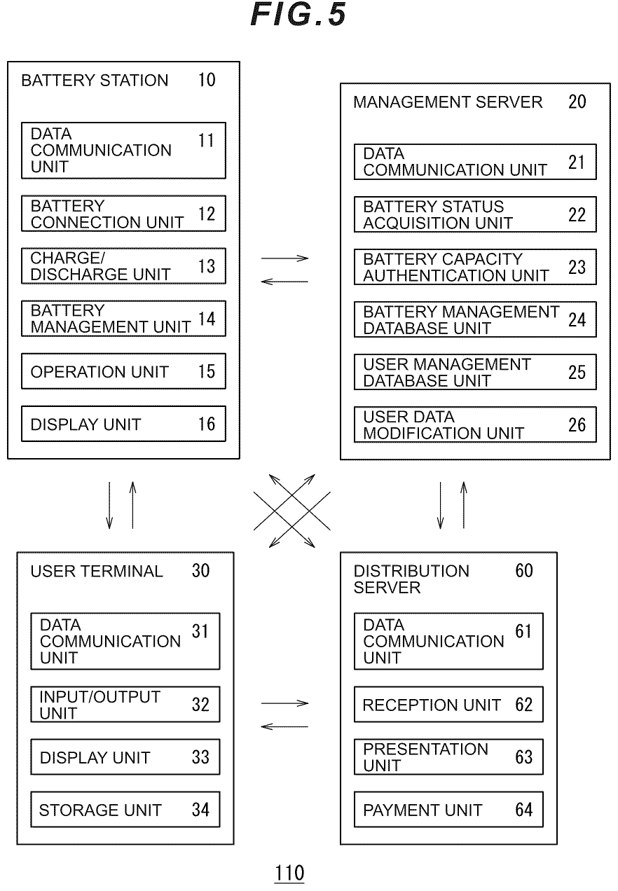

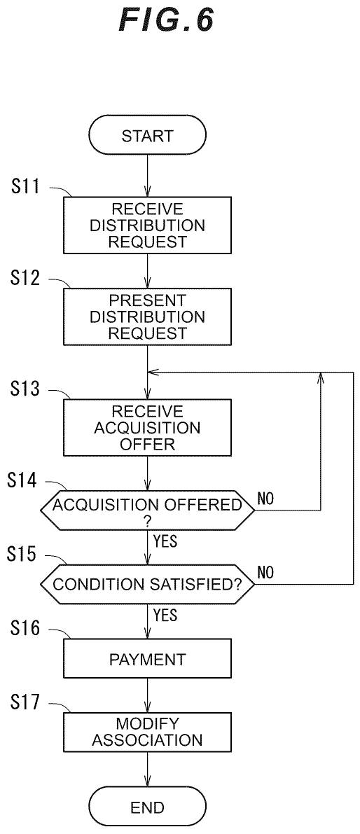

Next, a second embodiment of the present invention is described with reference to FIG. 5 and FIG. 6. Description of details overlapping with those of the first embodiment is omitted. In this embodiment, the user 50 has ownership of a battery 40 and can transfer ownership of a used battery 40 to a third party. FIG. 5 is a block diagram schematically illustrating the configuration of a battery management system 110 according to this embodiment. As illustrated in FIG. 5, the battery management system 110 includes a battery station 10, a management server 20, a user terminal 30, and a distribution server 60, each of which is connected to perform data communication with each other.

The distribution server 60 is a data processing device connected to the management server 20, plural battery stations 10, and plural user terminals 30 in a data communicable manner and performs distribution management of batteries 40 according to a predetermined procedure. As illustrated in FIG. 5, the distribution server 60 includes a data communication unit 61, a reception unit 62, a presentation unit 63, and a payment unit 64.

The data communication unit 61 is a part that performs data communication with the outside of the distribution server 60. The configuration of the data communication unit 61 is not limited in particular. It may be provided by wired connection or wireless connection. The communication protocol applied is not limited in particular, and a publicly known communication protocol may be used. Further, a publicly known data communication path may be used as the path for allowing the data communication unit 61 to perform data communication, such as an optical fiber network, a satellite communication network, a telephone line network, or a mobile communication network.

The reception unit 62 is a part that receives an instruction from a user 50 that has connected a battery 40 to the battery connection unit 12 or an instruction from another user (third party). The specific configuration of the reception unit 62 is not limited in particular. For example, the reception unit 62 may transmit data of a reception screen to the display unit 16 or the display unit 33 via the data communication unit 61 and receive input from the operation unit 15 or the input/output unit 32 as an instruction from the user 50 or the other user (third party).

The presentation unit 63 is a part that acquires authentication capacity of a battery 40 from the battery management database unit 24 and presents it to other users according to an instruction received from the user 50. The content to be presented to the other users by the presentation unit 63 may include, in addition to the authentication capacity, a manufacturing company, a model type, user data, and usage history that are recorded in association with the identification data in the battery management database unit 24. The type of the presentation unit 63 is not limited in particular. It may be a price presenting type or an auctioning type.

The payment unit 64 is a part that executes payment based on an instruction from the user 50 and another user. The specific configuration of the payment unit 64 is not limited in particular. Publicly known technology used for electronic commerce may be used. The payment unit 64 may be provided in the distribution server 60. Alternatively, the payment unit 64 may use an external payment server.

FIG. 6 is a flowchart illustrating a procedure of battery distribution of the battery management method according to this embodiment. Battery distribution of this embodiment is performed by replacing the option presentation step of step S7 and a portion of the selection step of step S8 in the battery management method illustrated in FIG. 1. In this embodiment, the user 50 is not only presented with the battery 40 for replacement in the option presentation step of step S7 but is also presented with an option to sell the battery 40 that was used. In the selection step of step S8, the procedure illustrated in FIG. 6 starts if the user 50 selects the option to sell.

Step S11 is a distribution request reception step for the reception unit 62 to receive a selling request of the battery 40 from the user 50. The reception unit 62 acquires the identification data and the authentication capacity of the battery 40 to be sold from the battery management database unit 24. Further, the reception unit 62 acquires the condition of sales input from the operation unit 15 or the input/output unit 32 as sales condition data. Then, the procedure proceeds to step S12. Here, the sales condition data may include, for example, prices, sales methods, and payment methods. The sales method may include data such as “sales only at quoted prices”, “acceptable discount rates”, and “sales through auctioning”.

Step S12 is a distribution request presentation step in which data regarding the battery 40 for sale and the intention to sell are presented to another user (third party). The presentation unit 63 presents the data of the battery 40 for sale to the other user based on the identification data acquired by the reception unit 62 and the sales condition data. At this time, the other user can grasp the actual chargeable capacity of the battery 40 and consider whether to purchase the battery 40 owing to the authentication capacity of the battery 40 is presented by the presentation unit 63. After the data of the battery 40 and the intention to sell are presented by the presentation unit 63, the procedure proceeds to step S13.

Step S13 is an acquisition offer reception step for receiving the intention of acquiring the battery 40 from another user. While the presentation unit 63 is presenting the data of the battery 40 and the intention to sell, the reception unit 62 serves to receive the intention of acquiring the battery 40 from another user as acquisition offer data. After the reception unit 62 receives the acquisition offer data, the procedure proceeds to step S14.

Step S14 is an offer determination step for determining whether the acquisition offer data received by the reception unit 62 is a valid acquisition offer with respect to the battery 40 for sale. The reception unit 62 transmits the acquisition offer data to the user data modification unit 26, and the user data modification unit 26 determines whether the acquisition offer data is a valid acquisition offer with respect to the battery 40 for sale. If the acquisition offer data is valid, the procedure proceeds to step S15. If the acquisition offer data is invalid, the procedure proceeds to step S13. The method of determining the validity of the acquisition offer data may be, for example, determining whether the user data of a third party is recorded in the user management database unit or whether the payment unit 64 can be used.

Step S15 is a transaction determination step for determining whether the sale condition data of the battery 40 for sale matches with the acquisition offer data. The user data modification unit 26 acquires the sales condition data acquired by the reception unit 62 in the distribution request reception step and determines whether the acquisition offer data satisfies the condition of the sale. If the result of the determination satisfies the condition, the procedure proceeds to step S16. If the result of the determination does not satisfy the condition, the procedure proceeds to step S13.

Step S16 is a payment process for executing the payment of the consideration of selling the battery 40 to the user 50. The payment unit 64 performs a process of paying the user 50 a sale consideration that is set in the sales condition data. After the payment process is completed, the procedure proceeds to step S17.

Step S17 is an association modification step for transferring ownership of the sold battery 40. The payment unit 64 transmits the data of the payment process to the user data modification unit 26, associates the user data of the submitter of the acquisition offer data whose payment has been completed with the identification data of the battery 40, and updates the user management database unit 25.

In this embodiment, the user 50 may select to sell the battery 40 using the distribution server 60, and a third party may confirm the authentication capacity of the battery 40 to apply for purchase. This allows the seller and the buyer to accurately grasp the chargeable capacity of the used battery 40 and set the appropriate price to execute the transfer of ownership. Therefore, in a case where, for example, the battery 40 deteriorates and is not suitable for the expected usage situation of the user 50 but is suitable for the expected usage situation of another user, appropriate transfer ownership and usage can be achieved according to the deterioration and chargeable capacity of the battery 40.

### Modified Example 1 of the Second Embodiment

In the battery management system and the battery management method illustrated in FIG. 5 and FIG. 6, the procedure proceeds to the distribution request reception step in step S11 when the user 50 selects the sale of the battery 40. However, the distribution request reception step may be executed automatically when a predetermined condition is satisfied.

In this modified example, the user 50 records beforehand a sales threshold value, which is a predetermined authentication capacity, in the user data in the user management database unit 25 as a scheduled sales condition. In the battery capacity authentication step of step S6, when the authentication capacity of the battery 40 falls below the sales threshold value, the battery management unit 14 omits the option presentation step of step S7 and the selection step of step S8 to proceed to step S11 at which the reception unit 62 receives the scheduled sales condition as the sales condition data.

In this modified example, because the user 50 sets the scheduled sales condition beforehand, the user 50 can sell a battery 40 without having to consider authentication capacity which is the chargeable capacity of the battery 40.

### Modified Example 2 of the Second Embodiment

In the battery management system and the battery management method illustrated in FIG. 5 and FIG. 6, another user confirms the content of the presentation unit 63 and offers to acquire a battery in the acquisition offer reception step of step S13. However, the offer for the acquisition may be executed automatically when a predetermined condition is satisfied.

In this modified example, another user records beforehand a purchase threshold value, which is a predetermined authentication capacity, in the user data in the user management database unit 25 as a scheduled purchase condition. In the acquisition offer reception step of step S13, the reception unit 62 acquires a scheduled purchase condition from the user management database unit 25, receives it as the acquisition offer data, and proceeds to a subsequent step. In step S15, the user data modification unit 26 determines whether the sales condition data satisfies the scheduled purchase condition which is the acquisition offer data. When the result of the determination satisfies the condition, the procedure proceeds to step S16, and when the result of the determination does not satisfy the condition, the procedure proceeds to step S13.

In this modified example, another user can automatically purchase a battery 40 having an authentication capacity that satisfies a scheduled purchase condition set beforehand by the other user. This allows a collector company to collectively purchase batteries 40 with authentication capacities that have a deterioration rate less than 50% and perform regeneration and recycling.

### Modified Example 3 of the Second Embodiment

In the modified example 1 of this embodiment, the user 50 has ownership of the battery 40. However, it can be also be used when a manager of a battery station 10 has ownership of a battery 40 and has concluded a rental contract, a lease contract, or a subscription-type contract with the user 50 regarding the battery 40.

In this modified example, the manager of the battery station 10 records beforehand a sales threshold value, which is a predetermined authentication capacity, in the user data in the user management database unit 25 as a scheduled sales condition. The other configurations are similar to those of modified example 1. Further, the manager of the battery station 10 may also modify the sales condition as appropriate.

Thereby, a deteriorated battery 40 that satisfies the sales condition set by the manager of the battery station 10 can be automatically sold to a recycling company or a disassembling company via the distribution server 60 and a collection operation and reuse of resources can be requested. Accordingly, it becomes possible to check the degree of deterioration of a vast number of batteries 40 and efficiently conduct recycling. Further, allowing the manager of the battery station 10 to set the sales condition (threshold of the degree of deterioration) enables flexible adaption in a case where the life of the battery 40 is extended by technological innovation or the like or where there is a shortage of raw materials of batteries in the world market, and the distribution volume can be adjusted by controlling the collection timing of the battery 40 for reuse and recycling, etc.

### Modified Example 4 of the Second Embodiment

In this modified example, the user 50 who purchased an electric vehicle or an electric two-wheel vehicle has ownership of the battery 40 which is an accessory thereof and transfers the battery 40 to the manager of the battery station 10 upon using the battery station 10. The user 50 may receive money as consideration for the transfer of ownership of the battery 40 or may enter into a subscription-type contract for the use of the battery station 10.

In this case, the user 50 brings his/her battery 40 to the battery station 10 and connects the battery 40 to the battery connection unit 12. In the battery station 10, the battery management unit 14 displays the content of a transfer contract on the display unit 16 and concludes the transfer contract through an operation performed on the operation unit 15 by the user 50. Then, the battery 40 is used and managed in a similar manner as in the second embodiment and the modified examples 1 to 3 of the second embodiment.

Further, the battery management unit 14 acquires secondary battery data from the battery 40 connected to the battery connection unit 12 by the battery status acquisition unit 22 upon concluding a contract with the user 50. The battery capacity authentication unit 23 calculates the chargeable capacity of the battery based on the electrical characteristic data included in the secondary battery data acquired by the battery status acquisition unit 22 and authenticates the capacity as the authentication capacity. The battery management unit 14 may request the user to pay for consideration or to deposit the difference amount required for concluding the contract based on the authentication capacity that the battery capacity authentication unit 23 has authenticated.

In this modified example, the user 50 originally owns a battery 40 and can use the battery 40 under his/her control until the battery 40 has deteriorated. Further, the user can use many of the good batteries 40 managed at the battery station 10 by submitting deteriorated batteries 40. Thereby, the transfer of ownership of deteriorated batteries 40 is facilitated. Thus, each individual does not need to store batteries 40 in a deteriorated state, and the batteries 40 can be collected in a recycling cycle to be reused and recycled.

### Third Embodiment

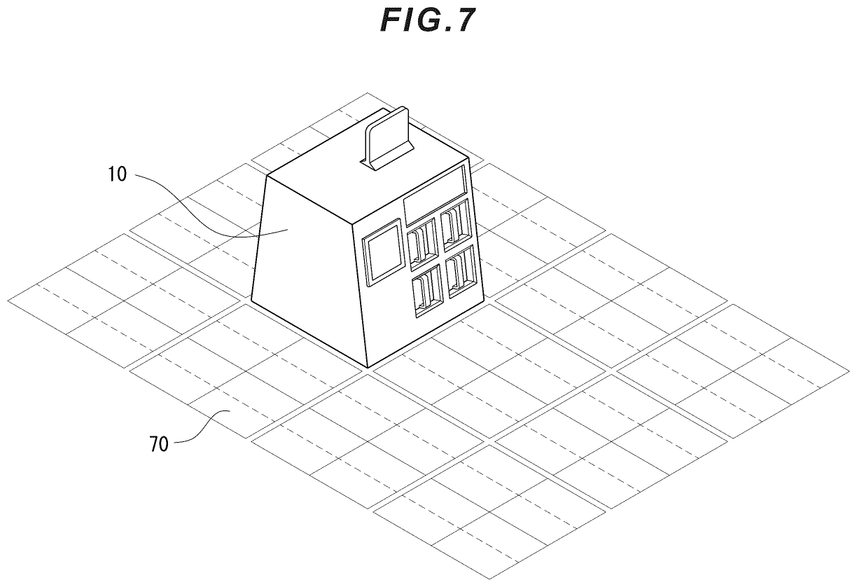

Next, a third embodiment of the present invention is described with reference to FIG. 7. Details overlapping with those of the first embodiment are omitted. In this embodiment, the battery station 10 is used as an autonomous type power generation station. As illustrated in FIG. 7, plural road power generation panels 70 are laid around the battery station 10 of this embodiment.

A road power generation panel 70 is provided by arranging a photovoltaic power generation panel on a road. The road power generation panel 70 is a member that generates electric power from incident light and supplies it the battery station 10. Plural road power generation panels 70 are electrically connected to each other in series or in parallel. The specific configuration of the road power generation panel 70 is not limited in particular. For example, the road power generation panel 70 may include a solar power generation panel of amorphous silicon, an impact buffer member such as polycarbonate which transmits light, and a non-slip layer in which an aggregate made of ceramic particles is dispersed in a transparent resin.

The electric power generated by the road power generation panel 70 is supplied to the battery station 10 and used to charge the battery 40 connected to the battery connection unit 12. Further, apart from accommodating a battery 40 used by the user 50 in the accommodation part, it is preferable to provide a storage battery (not illustrated) for temporarily storing electric power generated by the road power generation panel 70. The storage battery may be accommodated inside the battery station 10 or buried underground below the road power generation panel 70. In a case where the battery station 10 is provided with the storage battery, the electric power generated by the road power generation panel 70 is stored in the storage battery, and electric power is supplied from the storage battery to charge the battery 40 connected to the battery connection unit 12.

In the battery station 10 of this embodiment, because the charging of the battery 40 is performed by the electric power generated by the road power generation panel 70, the charging and management of the battery 40 can be performed autonomously even when there is no power supply from the outside. Therefore, even in areas where it is difficult to supply electricity from the outside, such as mountainous areas and islands, the usage and management of the battery 40 can be performed continuously.

Further, the battery station 10 may be provided with an output unit for outputting electric power, so that the electric power stored in the battery 40 connected to the battery connection unit 12 or the storage battery may be supplied from the output unit. This enables usage and management of the battery 40 in a regular situation while the electric power stored throughout the battery station 10 can be used as an emergency power source in an emergency situation.

### Fourth Embodiment

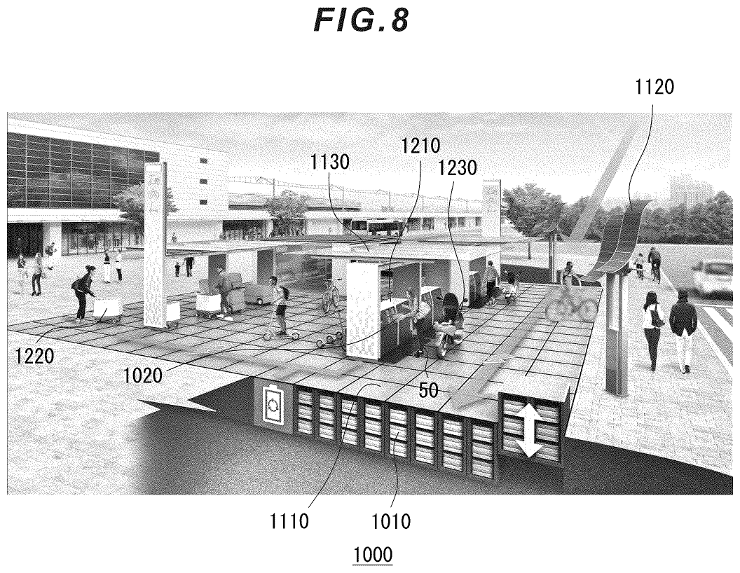

Next, a fourth embodiment of the present invention is described with reference to FIG. 8. Details overlapping with those of the first embodiment are omitted. FIG. 8 is a schematic diagram illustrating an outline of a battery replacement area 1000 according to this embodiment. As illustrated in FIG. 8, the battery replacement area 1000 includes a power storage unit 1010, a road power generation panel 1110, a street light power generation panel 1120, a rooftop power generation panel 1130, a battery station 1210, a mobile power supply 1220, and an electric mobile object 1230.

The road power generation panel 1110 is a photovoltaic power generation panel arranged on a road. The road power generation panel 1110 generates electric power from incident light and supplies it to the battery station 1210. The street light generation panel 1120 is a photovoltaic panel arranged on a street light. The street light generation panel 1120 generates electric power from incident light and supplies it to the battery station 1210. The rooftop power generation panel 1130 is a photovoltaic power generation panel arranged on a roof. The rooftop power generation panel 1130 generates electric power from incident light and supplies it to the battery station 1210.

The power storage unit 1010 is buried underground of the battery replacement area 1000 and has plural secondary batteries connected in series and in parallel. The power storage unit 1010 is connected to the road power generation panel 1110, the street light power generation panel 1120, and the rooftop power generation panel 1130 to store electric power generated by these power generation panels and supply it power to the battery station 1210. The power storage unit 1010 is a replaceable unit type and preferably uses reused or recycled batteries 1020 with progressed deterioration. Further, the power storage unit 1010 may be connected to a commercial power supply network to perform a charge/discharge operation by selling or purchasing electric power.

The battery station 1210, which is powered by the road power generation panel 1110, the street light power generation panel 1120, and the rooftop power generation panel 1130, is a device that connects batteries 1020 to perform charging, discharging, and usage permission to a user. The mobile power supply device 1220 is a power supply device that accommodates the battery 1020 and performs a charge/discharge operation. The electric mobile object 1230 is a mobile object that moves by using the electric power stored in the battery 1020 as its power source. The electric mobile object 1230 may be, for example, an electric vehicle or an electric two-wheel vehicle.

The user 50 rides the electric mobile object 1230 to visit the battery replacement area 1000, removes the battery 1020 loaded onto the electric mobile object 1230, and connects the battery 1020 to the battery station 1210. Further, the user 50 may bring the mobile power supply 1220 to the battery replacement area 1000, removes the battery 1020 loaded onto the mobile power supply 1220, and connects the battery 1020 to the battery station 1210. The battery station 1210 manages, for example, the charging, discharging, replacement, and sales of the battery 1020 with the methods described above in the first to third embodiments.

In this embodiment, the electric power generated by sunlight is stored in the power storage unit 1010, and a wide variety of batteries 1020 used in the electric mobile object 1230 or the mobile power supply device 1220 are managed. Thereby, the efficiency of management and recycling of batteries 1020 can be increased and the environmental burden can be reduced by the usage of natural energy.

The present invention is not limited to the above-mentioned embodiments, and various modifications can be made within the scope shown in the claims, and embodiments obtained by appropriately combining technical components disclosed in different embodiments are also included in the technical scope of the present invention.

### DESCRIPTION OF THE REFERENCE NUMERALS

100, 110 . . . Battery management system
1000 . . . Battery replacement area
1, 1210 . . . Battery station
11 . . . Data communication unit
12 . . . Battery connection unit
13 . . . Charge/discharge unit
14 . . . Battery management unit
15 . . . Operation unit
16 . . . Display unit
20 . . . Management server
21 . . . Data communication unit
22 . . . Battery status acquisition unit
23 . . . Battery capacity authentication unit
24 . . . Battery management database unit
25 . . . User management database unit
26 . . . User data modification unit
30 . . . User terminal
31 . . . Data communication unit
32 . . . Input/output unit
33 . . . Display unit
34 . . . Storage unit
40, 1020 . . . Battery
41 . . . Secondary battery
42 . . . BMS
43 . . . Station connection unit
44 . . . Storage unit
45 . . . Data communication unit
50 . . . User
60 . . . Distribution server
61 . . . Data communication unit
62 . . . Reception unit
63 . . . Presentation unit
64 . . . Payment unit
70, 1110 . . . Road power generation panel
1010 . . . Power storage unit
1120 . . . Street light power generation panel
1130 . . . Rooftop power generation panel
1220 . . . Mobile power supply device
1230 . . . Electric mobile object

1. A battery management system for performing charging and discharging of a secondary battery connected to a battery station and managing the secondary battery with a management server communicably connected to the battery station, the battery management system comprising:
a battery status acquisition unit configured to acquire, as secondary battery data, identification data that specifies and identifies the secondary battery and electrical characteristic data that indicates electrical characteristics of the secondary battery when connected, when charging or when discharging;
a battery capacity authentication unit configured to calculate a chargeable capacity of the secondary battery based on the electrical characteristic data and authenticate the chargeable capacity as an authentication capacity;
a battery management database unit provided in the management server and configured to record the identification data in association with the authentication capacity;
a user management database configured to record user data related to a user of the secondary battery in association with the identification data; and
a user data modification unit configured to modify the association between the user data and the identification data.

2. The battery management system according to claim 1,
wherein the user data modification unit is configured to modify the association between the user data and the identification data based on the authentication capacity.

3. The battery management system according to claim 1,
further comprising: a user terminal communicably connected to the battery station or the management server,
wherein the user data modification unit is configured to modify the association between the user data and the identification data based on an input result from the user terminal.

4. The battery management system according to claim 1,
further comprising: a distribution server communicably connected to the management server;
wherein the distribution server includes a presentation unit configured to present the authentication capacity of the secondary battery identified by the identification data to another user, and a receiving unit configured to receive acquisition offer data from the other user,
wherein the user data modification unit is configured to modify the association between the user data and the identification data based on the acquisition offer data.

5. The battery management system according to claim 1,
wherein the electrical characteristic data includes one of a full charge voltage, a full discharge voltage, an open circuit voltage, a closed circuit voltage, a charge characteristic, a discharge characteristic, an internal resistance, a temperature characteristic, a load characteristic, a cyclic use history data, or impedance.

6. The battery management system according to claim 1,
wherein the battery management database is configured to record a plurality of acquisition times and dates of the electrical characteristic data in association with the identification data,
wherein the battery capacity authentication unit is configured to authenticate the authentication capacity based on a temporal change of the electrical characteristic data.

7. A battery management method comprising:
a battery status acquisition step for acquiring secondary battery data including identification data that specifies and identifies a secondary battery and electrical characteristic data that indicates electrical characteristics of the secondary battery when connected, when charging or when discharging;
a battery capacity authentication step for calculating a chargeable capacity of the secondary battery based on the electrical characteristic data and authenticating the chargeable capacity as an authentication capacity;
a battery data management step for recording the identification data in association with the authentication capacity;
a user management step for recording user data related to a user of the secondary battery in association with the identification data; and
a user data modification step for modifying the association between the user data and the identification data.

8. A non-transitory computer readable recording medium on which a battery management program is recorded, the battery management program comprising:
a battery status acquisition procedure for acquiring secondary battery data including identification data that specifies and identifies a secondary battery and electrical characteristic data that indicates electrical characteristics of the secondary battery when connected, when charging or when discharging;
a battery capacity authentication procedure for calculating a chargeable capacity of the secondary battery based on the electrical characteristic data and authenticating the chargeable capacity as an authentication capacity;
a battery data management procedure for recording the identification data in association with the authentication capacity;
a user management procedure for recording user data related to a user of the secondary battery in association with the identification data; and
a user data modification procedure for modifying the association between the user data and the identification data.

9. The battery management system according to claim 2,
further comprising: a user terminal communicably connected to the battery station or the management server,
wherein the user data modification unit is configured to modify the association between the user data and the identification data based on an input result from the user terminal.

10. The battery management system according to claim 2,
further comprising: a distribution server communicably connected to the management server;
wherein the distribution server includes a presentation unit configured to present the authentication capacity of the secondary battery identified by the identification data to another user, and a receiving unit configured to receive acquisition offer data from the other user,
wherein the user data modification unit is configured to modify the association between the user data and the identification data based on the acquisition offer data.

11. The battery management system according to claim 3,
further comprising: a distribution server communicably connected to the management server;
wherein the distribution server includes a presentation unit configured to present the authentication capacity of the secondary battery identified by the identification data to another user, and a receiving unit configured to receive acquisition offer data from the other user,
wherein the user data modification unit is configured to modify the association between the user data and the identification data based on the acquisition offer data.

12. The battery management system according to claim 9,
further comprising: a distribution server communicably connected to the management server;
wherein the distribution server includes a presentation unit configured to present the authentication capacity of the secondary battery identified by the identification data to another user, and a receiving unit configured to receive acquisition offer data from the other user,
wherein the user data modification unit is configured to modify the association between the user data and the identification data based on the acquisition offer data.

13. The battery management system according to claim 2,
wherein the electrical characteristic data includes one of a full charge voltage, a full discharge voltage, an open circuit voltage, a closed circuit voltage, a charge characteristic, a discharge characteristic, an internal resistance, a temperature characteristic, a load characteristic, a cyclic use history data, or impedance.

14. The battery management system according to claim 3,
wherein the electrical characteristic data includes one of a full charge voltage, a full discharge voltage, an open circuit voltage, a closed circuit voltage, a charge characteristic, a discharge characteristic, an internal resistance, a temperature characteristic, a load characteristic, a cyclic use history data, or impedance.

15. The battery management system according to claim 4,
wherein the electrical characteristic data includes one of a full charge voltage, a full discharge voltage, an open circuit voltage, a closed circuit voltage, a charge characteristic, a discharge characteristic, an internal resistance, a temperature characteristic, a load characteristic, a cyclic use history data, or impedance.

16. The battery management system according to claim 9,
wherein the electrical characteristic data includes one of a full charge voltage, a full discharge voltage, an open circuit voltage, a closed circuit voltage, a charge characteristic, a discharge characteristic, an internal resistance, a temperature characteristic, a load characteristic, a cyclic use history data, or impedance.

17. The battery management system according to claim 2,
wherein the battery management database is configured to record a plurality of acquisition times and dates of the electrical characteristic data in association with the identification data,
wherein the battery capacity authentication unit is configured to authenticate the authentication capacity based on a temporal change of the electrical characteristic data.

18. The battery management system according to claim 3,
wherein the battery management database is configured to record a plurality of acquisition times and dates of the electrical characteristic data in association with the identification data,
wherein the battery capacity authentication unit is configured to authenticate the authentication capacity based on a temporal change of the electrical characteristic data.

19. The battery management system according to claim 4,
wherein the battery management database is configured to record a plurality of acquisition times and dates of the electrical characteristic data in association with the identification data,
wherein the battery capacity authentication unit is configured to authenticate the authentication capacity based on a temporal change of the electrical characteristic data.

20. The battery management system according to claim 5,
wherein the battery management database is configured to record a plurality of acquisition times and dates of the electrical characteristic data in association with the identification data,
wherein the battery capacity authentication unit is configured to authenticate the authentication capacity based on a temporal change of the electrical characteristic data.
